(19) United States
(12) Patent Application Publication
(10) Pub. No.: US 2004/0199659 A1
(43) Pub. Date: Oct. 7, 2004

(54) Information processing apparatus, information processing method, data communication system and program

(75) Inventors: Masayuki Ishikawa, Chiba (JP); Daisuke Imiya, Kanagawa (JP); Takao Morita, Tokyo (JP)

Correspondence Address: LERNER, DAVID, LITTENBERG,, KRUMHOLZ & MENTLIK, 600 SOUTH AVENUE WEST, WESTFIELD, NJ, 07090, US

(73) Assignee: Sony Corporation, Tokyo (JP)

(21) Appl. No.: 10/744,893

(22) Filed: Dec. 23, 2003

(30) Foreign Application Priority Data
Dec. 24, 2002 (JP) 2002-371426
Mar. 3, 2003 (JP) 2003-055145

(51) Int. Cl. G06F 15/16

(52) U.S. Cl. 709/235

(57) ABSTRACT

An information processing apparatus includes a first receiver operable to receive predetermined information including a transmission state of data transmitted from another information processing apparatus, a congestion estimation unit operable to estimate congestion of a network on the basis of the predetermined information received by the first receiver, a control signal generator operable to generate a first control signal for controlling a data transmission rate of the another information processing apparatus based on the congestion estimated by the congestion estimation unit, and a first transmitter operable to transmit the first control signal generated by the control signal generator to the another information processing apparatus.

### CROSS REFERENCES TO RELATED APPLICATIONS

The present application claims priority from Japanese Application Nos. JP 2003-055145, filed Mar. 3, 2003, and JP 2002-371426, filed Dec. 24, 2002, the disclosures of which are hereby incorporated by reference herein.

### BACKGROUND OF THE INVENTION

The present invention relates to an information processing apparatus, an information processing method, a data communication system and a program, and more particular to an information processing apparatus, an information processing method, a data communication system and a program which can transmit data at an optimum data transmission rate according to the status of a network.

A method was proposed (see, for example, Japanese Patent Application Laid-Open Publication No. 2002-204278) as an adaptive rate control method in data transmission and reception which use the real time transfer protocol (RTP) and the RTP control protocol (RTCP). In the method, an apparatus on a transmission side estimates the transmission state of data to control the transmission rate of the data on the basis of the information described in a receiver report (RR) packet of the RTCP by which an apparatus on a data reception side informs the apparatus on the data transmission side of a packet loss rate, a jitter and the like.

The method makes it possible to lower the data transmission rate by means of values such as packet loss rates, jitters and the like which are included in RR packets when the packets are lost, or the jitters become large owing to the congestion of a network.

Moreover, a method was proposed (see, for example, Japanese Patent Application Laid-Open Publication No. Hei 11-308271) in which an apparatus on a data transmission side detects the congestion of a network on the basis of delays of arrivals of packets, and the apparatus controls the data transmission rate on the basis of the detection result.

FIG. 1 illustrates a conventional data communication system. In FIG. 1, data transmitted by a transmission side terminal 1 is received by a reception side terminal 2 through a network 3.

A data generation unit 11 of the transmission side terminal 1 generates data to be transmitted to the reception side terminal 2, and outputs the data to a data transmission unit 12. The data transmission unit 12 divides the supplied data into suitable sizes, and adds a sequence number and a time when the data is to be transmitted to each piece of divided data. Then, the data transmission unit 12 sends the divided data to the reception side terminal 2 through the network 3. At this time, the data transmission unit 12 adjusts the transmission rate of the data by adjusting the size of the division of the data and the intervals of the transmission of the divided data in accordance with the transmission rate specified by a transmission rate change unit 13.

A reception report reception unit 15 receives a reception report transmitted from the reception side terminal 2, and supplies the contents of the report to a network buffer data quantity calculation unit 14. The network buffer data quantity calculation unit 14 calculates a round-trip time of the data on the basis of the contents of the report, and obtains a network buffer data quantity on the basis of the calculated round-trip time. The transmission rate change unit 13 receives the information indicating the network buffer data quantity from the network buffer data quantity calculation unit 14, and determines a transmission rate in order that the network buffer data quantity may be close to a predetermined target network buffer data quantity. Then, the transmission rate change unit 13 specifies the transmission rate to the data transmission unit 12.

On the other hand, a data reception unit 21 in the reception side terminal 2 receives the data to which the sequence number and the transmission time information have been added through the network 3, and supplies the received data to a data processing unit 22. The data processing unit 22 executes, for example, the decoding, the display processing and the like of the supplied data.

Moreover, the data reception unit 21 measures the information related to a data reception time, a received data quantity and the like on the basis of the sequence number and the transmission time information which are added to the data, and periodically supplies the measurement results to a reception report generation unit 23. The reception report generation unit 23 calculates a reception rate necessary for the generation of the reception report on the basis of the supplied information, and adds a reception sequence number, a data transmission time, a data reception time and a reception report transmission time to the calculated reception rate to output the reception rate including the added information to a reception report transmission unit 24. The reception report transmission unit 24 transmits the supplied reception report to the reception report reception unit 15 of the transmission side terminal 1 through the network 3.

When data transfer and reception by the transmission side terminal 1 and the reception side terminal 2 of FIG. 1 are performed by means of the RTP, the transmission side terminal 1, which has received an RTCP receiver report packet, i.e. an RR packet, measures the round trip time (RTT) of the RTCP to measure the delay of data transfer. The method can be realized only by means of a reference frame of the RTCP, and consequently the method has an advantage that the RTT can be measured even if the internal time of the transmission side terminal 1 and the internal time of the reception side terminal 2 are different from each other.

In the transmission side terminal 1 and the reception side terminal 2 of FIG. 1, a target network buffer data quantity is previously set, and a network buffer data quantity is obtained by the transmission side terminal 1 on the basis of a reception bit rate included in a reception rate and an RTT. Thereby, rate control is performed.

Moreover, a method for finding out the optimum rate by varying the rate of a transmission side up and down has been proposed (see, for example, Japanese Patent Application Laid-Open Publication No. Hei 11-341064).

The method, basically similarly to the case shown in Japanese Patent Application Laid-Open Publication No. Hei 11-308271, controls the transmission rate by detecting the transmission delay (the delay to an RTT) of a packet on the transmission side on the basis of information from a reception side terminal by means of the sender report (SR) packets and the RR packets of the RTCP.

Moreover, there is a technique capable of controlling data transmission rates by estimating the transmission bandwidth of a network on the data reception side to transmit a transmission control instruction from the data reception side to the data transmission side on the basis of the estimated transmission bandwidth (see, for example, Japanese Patent Application Laid-Open Publication No. 2000-115245).

According to the method, the transmission bandwidth can be obtained by transmitting, for example, a test packet.

However, it is generally difficult to presume the congestion state of a network by means of values such as a packet loss rate, a jitter and the like which are included in an RR packet.

Moreover, in a case of performing rate control by setting a target network buffer data quantity previously, and by obtaining a network buffer data quantity on a transmission side on the basis of a reception bit rate included in a reception rate and an RTT in order that the network buffer data quantity may coincide with the target network buffer data quantity, it is difficult to determine the optimum target network buffer data quantity previously in the state in which a network topology and the kind of a router are not specified.

Moreover, because it is necessary for measuring an RTT to utilize SR packets and RR packets of the RTCP, the RTT is measured as a value including congestion in the data transmission path from the reception side to the transmission side when the congestion occurs in the data transmission path from the reception side to the transmission side. Moreover, because the transmission interval of the RTCP depends on implementation (it is recommended that the interval be five seconds or more) , it is difficult, especially when the status of the network changes momentarily as in a wireless line, to control the transmission rate by measuring the RTT periodically.

Moreover, even if the transmission and the reception of the SR packets and the RR packets are implemented, because the transmission rate setting method on the transmission side depends on algorithms implemented on the transmission side, the congestion is not always avoided on the basis of the contents of the RR packets informed from the reception side.

Moreover, it is necessary to use packet data of at least two packet sizes for obtaining the transmission bandwidth of a network, i.e. the speed of a bottleneck link in the case where the transmission bandwidth of the network is estimated on the data reception side and transmission control instruction is performed on the data reception side on the basis of the estimation. Consequently, the method cannot be applied to the transmission and the reception of the data executed by being packetized at a fixed length as in the case where, for example, Motion Picture Experts Group 2 over Internet Protocol Transfer System (MPEG 2-TS) is packetized to be an RTP packet in accordance with a Request For Comment (RFC) 2250 to be transmitted.

Moreover, because the transmission bandwidth of a network estimated on the data reception side is the bandwidth of the so-called bottleneck link, a data transmission path is controlled on the basis of the bandwidth of the bottleneck link, even if the actually utilizable bandwidth is narrower than the bandwidth of the bottleneck link due to, for example, cross traffic or the like. Consequently, there is the possibility that data is transmitted at a data transmission rate which is not based on the actual network status.

### SUMMARY OF THE INVENTION

The present invention was made in view of such status, and makes it possible to control a data transmission rate according to the state of a network even if the network topology or the kind of router cannot be specified, or if the bandwidth utilizable in the network changes owing to cross traffic or the like.

A first information processing apparatus of the present invention includes a first receiver operable to receive from another information processing apparatus predetermined information including a transmission state of transmitted data; a congestion estimation unit operable to estimate congestion of a network on the basis of the predetermined information received by the first receiver; a control signal generator operable to generate a first control signal for controlling a data transmission rate of the another information processing apparatus on the basis of the congestion estimated by the congestion estimation unit; and a first transmitter operable to transmit the first control signal generated by the control signal generator to the another information processing apparatus.

The congestion estimation unit may include a delay detection unit operable to detect a delay in data transmission in the network on the basis of the predetermined information received by the first receiver, and the control signal generator may generate the first control signal on the basis of the delay in data transmission detected by the delay detection unit.

The predetermined information may include a first clock for data transmission processing in the another information processing apparatus and, when the first clock coincides with a second clock used for data reception processing in the delay detection unit, the delay detection unit can detect the delay in data transmission using the first and second clocks as a first reference clock. When the first clock is different from the second clock, the delay detection unit can detect the delay in data transmission using a second reference clock different from the first reference clock.

It is possible that the data is an RTP packet based on RFC 1889, and that the first reference clock is NTP. Further, the second reference clock may be a clock different from the first reference clock equipped in the delay detection unit itself.

The information processing apparatus may further include a reception time measurement unit operable to measure the time when the predetermined information is received by the first receiver, and the delay detection unit may detect a relative delay in data transmission on the basis of a plurality of pieces of reception time of the predetermined information measured by the reception time measurement unit when the first clock is different from the second clock, and when mapping functions of the second reference clock and the first reference clock cannot be calculated.

It is possible that the data is composed of a packet in a predetermined size, and that the predetermined information includes information of a reception number of the packet and a number of packet losses.

The congestion estimation unit may further include a packet loss rate detection unit operable to detect a packet loss rate of the packets transmitted from the another information processing apparatus on the basis of the predetermined information received by the first receiver, and the control signal generator may generate the first control signal on the basis of the packet loss rate detected by the packet loss rate detection unit and the delay in data transmission detected by the delay detection unit.

The control signal generator may cause the first control signal to lower when the delay detection unit detects an increase in the delay in data transmission equal to or greater than a first predetermined quantity, or when the packet loss rate detection unit detects a packet loss rate equal to or greater than a second predetermined quantity.

The control signal generator may cause the first control signal to rise when the delay detection unit does not detect an increase in the delay in data transmission equal to or greater than a first predetermined quantity for a predetermined time, and when the packet loss rate detection unit does not detect a packet loss rate equal to or greater than a second predetermined quantity for the predetermined time.

The congestion estimation unit may include a first congestion condition detection unit operable to detect a first condition for estimating the congestion of the network referring to a first time as a reference on the basis of the predetermined information, and a second congestion condition detection unit operable to detect a second condition for estimating the congestion of the network referring to a second time as a reference on the basis of the predetermined information.

The control signal generator may cause the first control signal to lower when the first congestion condition detection unit and the second congestion condition detection unit detect at least one of the first condition and the second condition.

The control signal generator may cause the first control signal to rise when the first congestion condition detection unit and the second congestion condition detection unit do not detect the first condition and the second condition for a predetermined time.

The information processing apparatus may further include a second transmitter operable to transmit the data to the another information processing apparatus; a second receiver operable to receive a second control signal for controlling a data transmission rate by the second transmitter from the another information processing apparatus; and a controller operable to control the data transmission rate transmitted from the second transmitter on the basis of the second control signal received by the second receiver.

As described above, according to the present invention, data can be received. In particular, it is possible to generate a control signal of a data transmission rate according to the status of a network, and to transmit the generated control signal to the apparatus on the transmission side.

Moreover, according to anther aspect of the present invention, besides the capability of transmitting data, a data transmission rate can be controlled on the basis of the control signal of the data transmission rate received from an apparatus on a data reception side.

Moreover, according to a further aspect of the present invention, in addition to the capability of transmitting and receiving data by two apparatuses, the following can be performed. That is, an apparatus on a data reception side can generate a control signal of a data transmission rate according to the status of a network, and can transmit the generated control signal to an apparatus on a transmission side. The apparatus on the data transmission side can control the data transmission rate on the basis of the control signal of the data transmission rate.

### BRIEF DESCRIPTION OF THE DRAWINGS

FIG. 1 is a view illustrating a conventional data communication system;

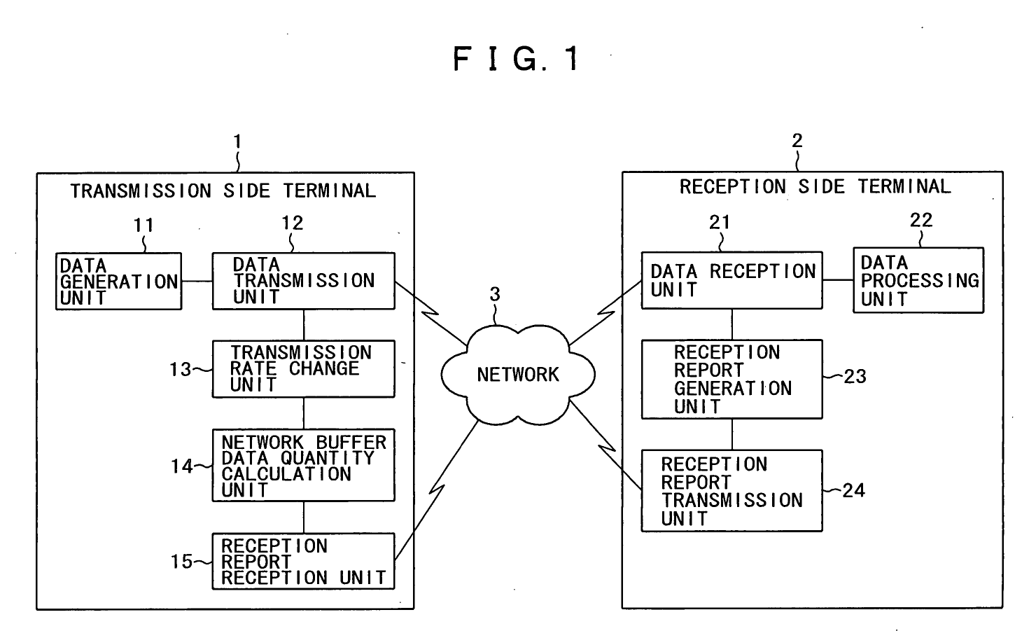

FIG. 2 is a block diagram showing the configurations of a data transmission apparatus and a data reception apparatus of a data communication system to which the present invention is applied;

FIG. 3 is a view illustrating an SR packet;

FIG. 4 is a view illustrating an RR packet;

FIG. 5 is a view illustrating an application defined RTCP packet (APP);

FIG. 6 is a block diagram showing the configuration of a congestion prediction unit in FIG. 2;

FIG. 7 is a diagram illustrating a simple decrease of delay due to reception time;

FIG. 8 is a diagram illustrating state transitions;

FIG. 9 is a diagram illustrating state transitions and data transmission rates;

FIG. 10 is a flowchart illustrating a statistical information generation process;

FIG. 11 is a flowchart illustrating a rate control process;

FIG. 12 is a flowchart illustrating a transmission rate change process;

FIG. 13 is a block diagram showing the configuration of a data transmission and reception apparatus in another example of the data communication system to which the present invention is applied; and

FIG. 14 is a block diagram showing the configuration of a personal computer.

### DETAILED DESCRIPTION

In the following, the preferred embodiment of the present invention will be described by reference to the attached drawings.

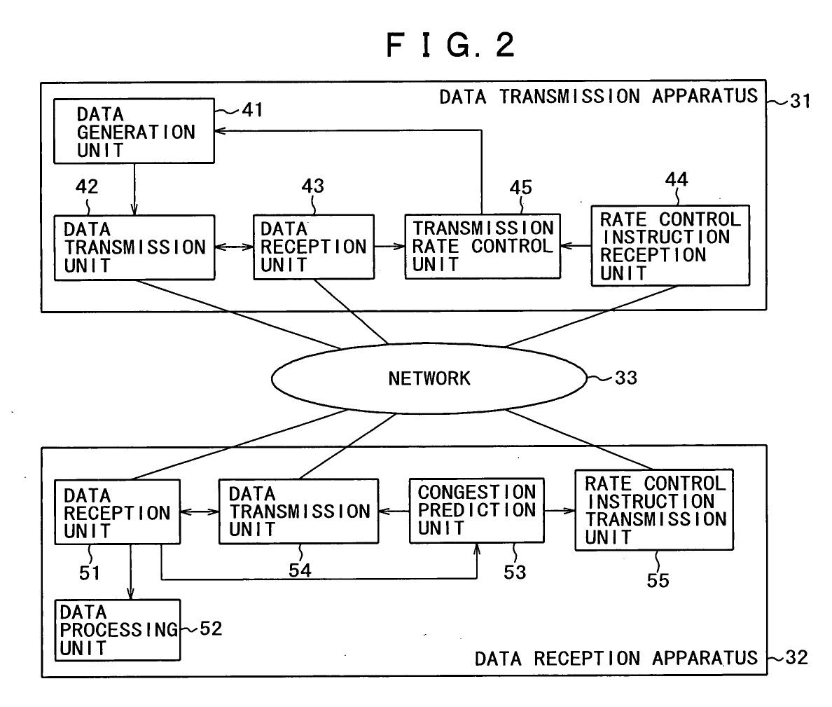

FIG. 2 is a block diagram showing the configurations of a data transmission apparatus 31 and a data reception apparatus 32 in a data communication system to which the present invention is applied.

The data transmission apparatus 31 and the data reception apparatus 32 perform the transfers of data in accordance with the RTP which is a real-time data transfer protocol. The RTP is designed with the purpose of transferring video data and audio data in a form suitable for real-time transmission on the supposition that the video data and the audio data are used by, for example, an application program for performing a teleconference, and the like. In the RTP, data is divided into packets per time to be transmitted. Moreover, the RTP is a user datagram protocol (UDP) type protocol in which a packet loss measure, the assurance of transmission time, and the like are not performed. The RTP is ordinarily used as a set together with a communication state report in accordance with the RTCP.

Moreover, the network 33 may be, for example, a local area network (LAN) managed within an organization, a large scale network to which many unspecified networks are connected, such as the Internet, or a dedicated line for connecting a predetermined transmission apparatus to a predetermined reception apparatus.

A data generation unit 41 of the data transmission apparatus 31 generates, for example, audio data, image data, video data, text data, or mixtures of these types of data, and supplies the generated data to a data transmission unit 42. The data quantity generated at this time is controlled by a transmission rate control unit 45.

When the data transmission unit 42 transmits the data supplied from the data generation unit 41 as RTP packets, the data transmission unit 42 adds a Sender Report (SR) packet by the RTCP to the data at every predetermined time, for example, every five seconds, and transmits the added data to the data reception apparatus 32 through the network 33. The SR packet is a report for a transmission and reception statistic on the data transmission side. In the SR packet, information indicating a data transmission state is described.

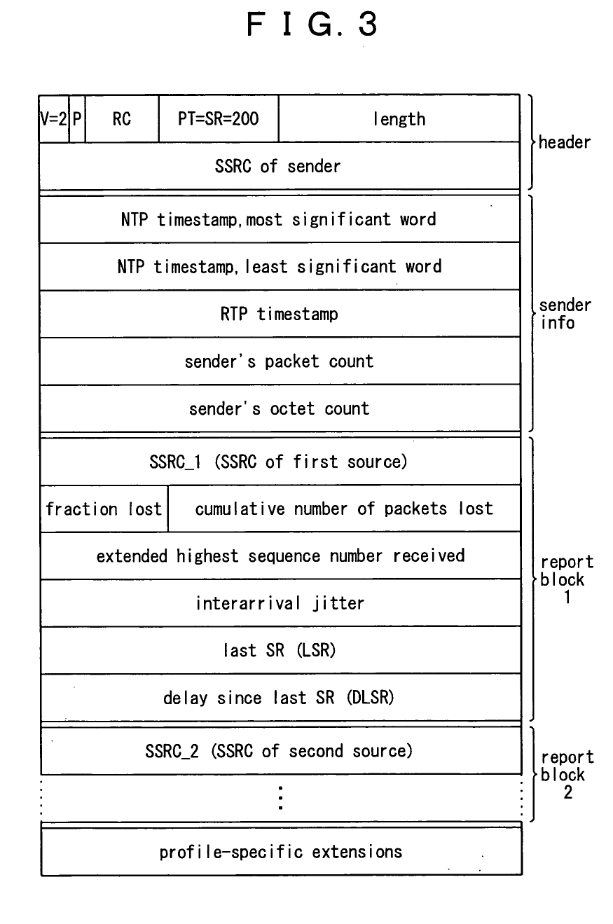

FIG. 3 shows the format of an SR packet. A header is composed of version information (V) being 2-bit information for identifying the version of the RTP, a 1-bit padding bit (P) being information indicating whether the packet includes one or more padding octets or not, a 5-bit reception report count (RC) indicating the number of reception report blocks included in the packet, an 8-bit packet type (PT) describing a constant 200 indicating an SR packet for discriminating between the SR packet and an RR packet, a packet length being 16-bit information indicating the length of the RTCP packet, and a sender SSRC identifier (SSRC of sender).

Then, sender information (Sender Info) is composed of a 64-bit network time protocol time stamp (NTP time stamp), a 32-bit real-time transport protocol time stamp (RTP time stamp), 32-bit sending packet number information (sender's packet count), and 32-bit sending data quantity information (sender's octet count).

A report block is composed of a 32-bit SSRC identifier number (SSRC_n (source identifier)), fraction lost indicating a packet loss rate, a cumulative number of packets lost, the maximum value of sequence numbers (extended highest sequence number received), inter-arrival jitter indicating a change of the arrival time interval of RTP packets, last SR (LSR) being information of a time stamp of the latest SR packet receiving time, and a delay since last SR (DLSR) indicating a delay from the LSR.

Moreover, an SR packet is further provided with a special extended area (profile-specific extensions).

As described above, an SR packet includes an NTP time stamp, and an RTP time stamp.

A data reception unit 43 receives an RR packet of the RTCP transmitted from the data reception apparatus 32. The RR packet is a report for a reception statistic from the data transmission side.

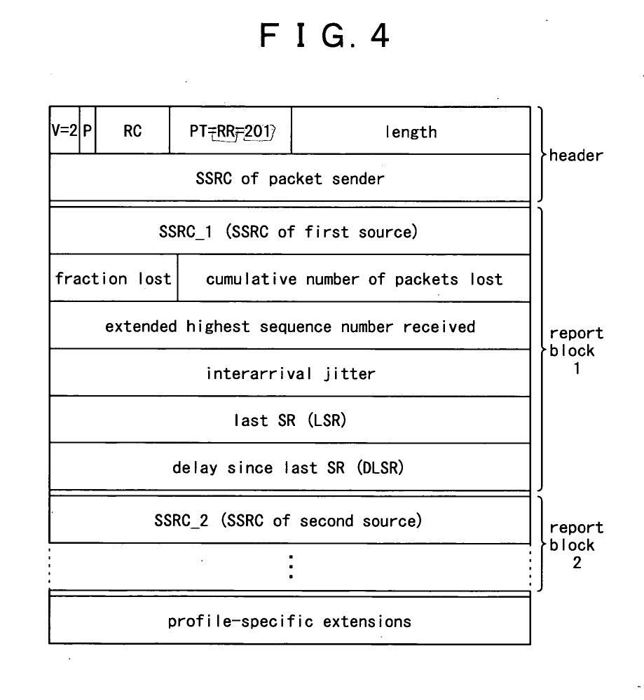

FIG. 4 shows the format of an RR packet.

The format of the RR packet has the same header structure as that of the SR packet except that a constant 201 indicating the RR packet is described in the packet type (PT), and that a sender SSRC identifier (SSRC of packet sender) of a received RTP packet is described in place of the sender SSRC identifier (SSRC of sender). The format of the RR packet does not include the sender information included in the SR packet, but includes a report block and a special expanded area similar to those of the SR packet.

A rate control instruction reception unit 44 receives a rate control instruction from the data reception apparatus 32 through the network 33, and supplies the received rate control instruction to the transmission rate control unit 45.

The transmission rate control unit 45 generates a transmission rate control signal on the basis of the rate control instruction supplied from the rate control instruction reception unit 44, and supplies the generated transmission rate control signal to the data generation unit 41.

A data reception unit 51 of the data reception apparatus 32 receives an SR packet and an RTP packet from the data transmission apparatus 31 through the network 33, and supplies, for example, the data of video, audio, text and the like of the RTP packet to a data processing unit 52. Moreover, the data reception unit 51 supplies the information necessary for estimating congestion, such as the reception time of the RTP packet, the time stamp, the packet size, the sequence number and the like, to a congestion prediction unit 53.

The data processing unit 52 processes the data supplied from the data reception unit 51. More particularly, the data processing unit 52 executes, for example, decoding processing, descramble processing, display processing, audio reproduction processing, and the like on the supplied data.

A data transmission unit 54 generates an RR packet, which has been described by reference to FIG. 4, to the RTP packet transmitted from the data transmission apparatus 31, and transmits the generated RR packet to the data transmission apparatus 31 through the network 33.

The congestion prediction unit 53 estimates the congestion of a data transmission path on the basis of the information supplied from the data reception unit 51, and sets a data reception rate (i.e., the data transmission rate of the data received by the data reception apparatus 32) on the basis of the estimation as the need arises. Then, the congestion prediction unit 53 generates a rate control instruction and supplies it to a rate control instruction transmission unit 55.

The rate control instruction transmission unit 55 transmits the rate control instruction supplied from the congestion prediction unit 53 to the data transmission apparatus 31 as an application defined RTCP packet (APP of the RTCP) through the network 33. The APP is a packet for extension of application.

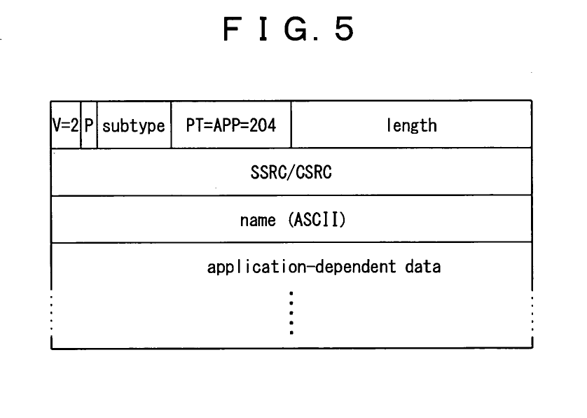

FIG. 5 shows the format of an APP.

The APP is composed of version information (V) being 2-bit information for identifying the version of the RTP, a 1-bit padding bit (P) being information indicating whether the packet includes one or more padding octets or not, a subtype for identifying definition of the packet, an 8-bit packet type (PT) describing a constant 204 indicating that the packet is an APP, a packet length being 16-bit information indicating the length of the RTCP packet, an SSRC identifier or a contributing source (CSRC) identifier being a transmitter concerned (an original sender ID in case of being mixed by a mixer), a name added to the APP peculiarly, which is described by means of the American National Standard Code for Information Interchange (ASCII) code, and information depending on the application (application dependent data).

Although the case where the transmission and the reception of data are executed in a plurality of blocks is described in the data transmission apparatus 31 and the data reception apparatus 32 in FIG. 2, the data transmission apparatus 31 may be configured to be able to execute the processing executed by the data transmission unit 42, the data reception unit 43, and the rate control instruction reception unit 44 by one or two transmission and reception functions. Otherwise, the data reception apparatus 32 may be configured to be able to execute the processing executed by the data reception unit 51, the data transmission unit 54, and the rate control instruction transmission unit 55 by one or two transmission and reception functions.

Next, the operation of the data transmission apparatus 31 and the data reception apparatus 32 will be described.

The data generation unit 41 of the data transmission apparatus 31 receives the operation input of a user from an operation input unit (not shown), and generates, for example, audio, image, video and text data, or a mixture of these types of data, and supplies the generated data to the data transmission unit 42. The quantity of the data generated at this time is controlled by the transmission rate control unit 45.

The data transmission unit 42 divides the data supplied from the data generation unit 41 into packets at every unit time, adds an SR packet to each of the divided packets at every predetermined time, and transmits the divided packets including the SR packet to the data reception apparatus 32 through the network 33.

The data reception unit 51 of the data reception apparatus 32 receives RTP packets and RTCP SR packets from the data transmission apparatus 31 through the network 33. The data reception unit 51 supplies the data of, for example, video, audio, text and the like to the data processing unit 52, and supplies the reception time, the time stamps, the sequence numbers of the RTP packets, the time information included in the SR packets, and the like to the congestion prediction unit 53.

Moreover, when a packet loss, such as the destruction of a frame owing to a bit error of an access line, the destruction of a packet in a bottleneck link or the like, occurs in a received packet, the data reception unit 51 supplies the information related to the packet loss to the congestion prediction unit 53.

The congestion prediction unit 53 obtains a delay of data and a packet loss rate on the basis of the information supplied from the data reception unit 51, and generates a rate control instruction as the need arises.

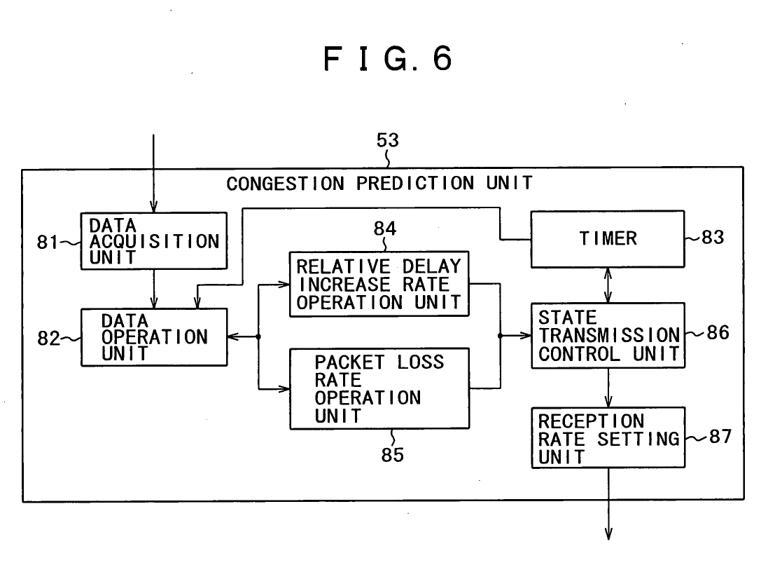

FIG. 6 shows a functional block diagram of the congestion prediction unit 53.

A data acquisition unit 81 acquires time information included in an SR packet, and the information necessary for acquiring the delay and the packet loss rate of the data of the reception time, the time stamp, the packet size, the sequence number and the like of an RTP packet from the data reception unit 51, and supplies the acquired data to a data operation unit 82.

The data operation unit 82 operates a one-way delay, a number of packet losses, a number of received packets, and the total sum of the byte count of received data in the data transmission from the data transmission apparatus 31 to the data reception apparatus 32 at a predetermined period of time, such as for five seconds or for ten seconds, by reference to the time information supplied from a timer 83, and generates statistical information.

When the time of the data transmission apparatus 31 and the time of the data reception apparatus 32 by the NTP coincide with each other, it is possible to obtain absolute delay time at the time accuracy of the NTP by performing mapping from the time stamps of the RTP included in the SR packets of the RTCP to the NTP. However, actually, there are many environments in which the NTP cannot be used.

Next, the method of measuring a delay in the case where the NTP cannot be used, namely, in the case where the time by the NTP in the data transmission apparatus 31 and the time by the NTP in the data reception apparatus 32 do not coincide with each other, will be described.

First, the absolute delay of each packet can be obtained by the following formula (1):

Delay of RTP Packet=Arrival Time [NTP] of RTP Packet−Transmission Time [NTP] of RTP Packet (1)

Hereupon, the content of brackets [ ] indicates the clock by which the time is referred to (it is similar in the following).

When the time by the NTP of the data transmission apparatus 31 and the time by the NTP of the data reception apparatus 32 are synchronized with each other and NTP information is correctly included in the SR packets of the RTCP, the next formula (2) is satisfied:

Delay of RTP Packet=Arrival Time [NTP] of RTP Packet−RTP Time Stamp (2)

Then, a mapping function f1 from the NTP to the RTP time stamps which correlates the transmission time of the RTP packets with the time stamps in the SR packets by means of the time stamps and the mapping information of the NTP is obtained as shown by the following formula (3):

RTP Time Stamp=f1 [NTP] (3)

Then, the delays of the RTP packets can be obtained in accordance with the following formula (4) by replacing the RTP time stamps in the formula (2) with the mapped time stamps.

Delay of RTP Packet=Arrival Time [NTP] of RTP Packet−f1 [NTP] (4)

On the other hand, when the mapping from the time stamps of the RTP to the NTP cannot be performed and the formula (3) cannot be obtained because, for example, the NTP of the SR packets is apparently shifted, or the SR packets cannot be received, it is necessary to measure the delays with the clock in the data reception apparatus 32. In this case, the delays of the RTP packets can be actually obtained by measuring relative delays to the arrival time of a certain RTP packet set as a base point.

For example, the time stamp of a first RTP packet is supposed to be TS1, and the reception time (in the unit of ms) of the first RTP packet is supposed to be TR1. The time stamp of the first RTP packet and the reception time of the first RTP packet are times to be measured on a reference different from that of the NTP. Hereupon, for synchronizing the units of time of the time stamp of the first RTP packet with the reception time of the first RTP packet, the reception time is multiplied by the reference clock of the RTP. In data communication by the RTP Payload format for MPEG-4 Elementary Stream (RFC3016), a clock of 90 KHz is used as the reference clock. Accordingly, when the unit of the reception time is ms, the next formula (5) may be used for converting the reception time to the reference clock of the time stamp.

Reception Time [Reference Clock]=TR1(ms)×90 (5)

Now, the first RTP packet to the n-th RTP packet are respectively supposed to be RTP 1 to RTPn, and respective time stamps are supposed to be TS1 to TSn. Then, if there is no congestion or packet loss in the network, the next formula (6) becomes almost a constant.

(Time Difference between Terminals+Delay of Packet) [Reference Clock]=TSn−(TRn×90) (6)

The TSn−(TRn×90) indicated by formula (6) is the time difference between the data transmission apparatus 31 and the data reception apparatus 32 in a case of the measurement by the reference clock of the RTP by means of the internal clock of the data reception apparatus 32. Incidentally, jitters and the disagreements of clocks between transmission and reception are neglected in the formula (6).

However, it is not known how long the time difference corresponds to the time difference in absolute time. That is, even if the value of the formula (6) is zero, the length of the delay of the packet cannot be obtained. Consequently, the data operation unit 82 sets the time difference including the delay of the packet between the data transmission apparatus 31 and the data reception apparatus 32 at a certain time as an initial time difference between terminals, and measures relative delays by a formula (7) on the basis of the initial time difference.

Relative Delay of RTP Packet [reference clock]=(TR×90−TS)−Initial Time Difference between Terminals (7)

It is noted that TR is the reception time (in the unit of ms) of the RTP packet, and TS is the time stamp of the RTP.

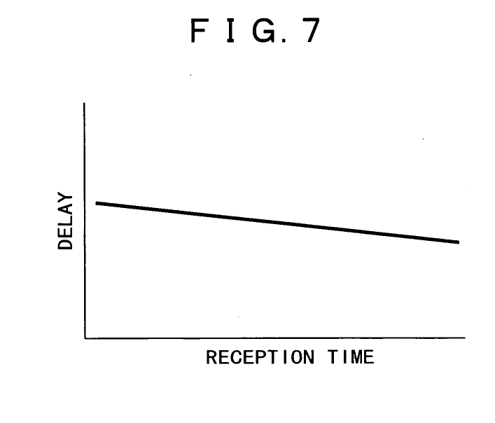

Now, as described above, in the formula (6), the jitters and the disagreement of the clocks between the transmission and the reception are neglected, and the difference of the time stamps between transmission and reception obtained from the formula (6) is supposed to be constant. However, actually, the sum of the time difference between the terminals expressed by the formula (6) and the delay of a packet shows a tendency of either gradual monotone decreasing or gradual monotone increasing owing to the disagreement between the basic clocks of the data transmission apparatus 31 and the data reception apparatus 32. For example, as shown in FIG. 7, a status of delays decreasing gradually as the reception time elapses occurs.

In such a case, when an initial time difference calculated by means of the formula (7) is continued to be used as the initial value, obtained relative delays also monotonously decrease or monotonously increase. Accordingly, it is necessary to update the initial time difference calculated by means of the formula (7) periodically.

Moreover, because the data operation unit 82 receives the supply of the number of packet losses, the number of received packets, and received data quantity (receive byte count), the data operation unit 82 refers to the timer 83 to obtain the total sum of the relative delays of the RTP packets, the number of packet losses, the number of received packets, and the total sum of the received data quantity (received byte count) at every predetermined time such as five seconds or ten seconds.

Next, a relative delay increase rate operation unit 84 determines the average relative delay of the RTP packets during a predetermined time (a period from time t1 to time t2) by means of the next formula (8) on the basis of the total sum of the relative delays of the number of received packets and the RTP packets, which total sum has been supplied from the data operation unit 82.

$$Average Relative Delay ( t1 , t2 ) of RTP Packet = ( {\sum }_{t1}^{t2} ( Relative Delay of RTP Packet ) ) / ( Number of Packets ) \qquad ( 8 )$$

Moreover, the relative delay increase rate operation unit 84 compares the average relative delay of an RTP packet which has been calculated by the use of the formula (8) with the average relative delay in the preceding section to calculate an average relative delay increasing rate D.

Then, a packet loss rate operation unit 85 obtains a packet loss rate L on the basis of the information supplied from the data operation unit 82.

A packet loss of an RTP packet generally occurs from the destruction of a frame due to a bit error of an access line, or by the destruction of a packet in a bottleneck link. The bit error of the access line can be prevented to some degree by an error correction, retransmission in a link layer (especially in a case of a wireless link), and the like. However, a certain measure of packet losses occur according to a condition of radio waves in an actual wireless link. Moreover, when the destruction of a packet occurs at a bottleneck link, the queue of the bottleneck link overflows to generate a packet loss. Consequently, in the case in which, for example, a first in first out (FIFO) type queue is used, a packet loss corresponding to the quantity of the overflow occurs.

That is, because the packet loss due to a bit error on an access line is estimated to occur at a certain measure of probability, the packet loss rate does not always lower by lowering the rate on the transmission side. However, when the destruction of a packet at a bottleneck link occurs, the packet loss continues to occur unless the rate on the transmission side is lowered.

Hereupon, the packet loss rate operation unit 85 determines a packet loss rate in accordance with the following formula (9):

Packet Loss Rate L=Number of Packet Losses/(Number of Received Packets+Number of Packet Losses) (9)

A state transition control unit 86 determines whether to make the control state of the reception rate transition on the basis of the average relative delay increase rate of RTP packets and packet loss rates which have been supplied from the relative delay increase rate operation unit 84 and the packet loss rate operation unit 85, respectively.

The state transition control unit 86 periodically compares the average relative delay increase rates with a predetermined threshold value H1 in accordance with a formula (10). When an average relative delay increase rate is larger than the threshold value H1, the state transition control unit 86 makes the control state transition to lower the reception rate.

Average Relative delay Increase Rate D>Threshold Value H1 (10)

Moreover, the state transition control unit 86 periodically compares packet loss rates within a predetermined short time (within a sufficiently shorter time, for example, a range from several 100 msec to 1 sec, than the period of time in a case of obtaining an average relative delay increase rate) with a predetermined threshold value H2 in accordance with a formula (11). When a packet loss rate is larger than the threshold value H2, the state transition control unit 86 makes the control state transition to lower the reception rate.

Packet Loss Rate L>Threshold Value H2 (11)

When the transmission bandwidth of the data transmission path between the data transmission apparatus 31 and the data reception apparatus 32 has a certain degree of largeness, the length of a queue in the network becomes relatively short. Consequently, when the state of the data transmission path becomes unstable, the packet loss rate easily increases. Hence, the formula (11) is more easily satisfied than the formula (10). On the contrary, when the transmission bandwidth of the data transmission path between the data transmission apparatus 31 and the data reception apparatus 32 is relatively small, the length of a queue in the network becomes relatively long. Consequently, when the state of the data transmission path becomes unstable, the average relative delay increase rate D easily increases. Hence, the formula (10) is more easily satisfied than the formula (11).

In such a method, it is determined whether the reception rate should be lowered on the basis of the two evaluation formulae (10) and (11). As a result, whether the data transmission bandwidth is large or small, it becomes possible to control the data reception rate to be most suitable for the state of the data transmission path.

Moreover, there is a case where the state transition control unit 86 makes the state transition for keeping the reception rate constant, or for raising the reception rate on the basis of a comparison result using the formula (10) and formula (11) when the data transmission state is stable.

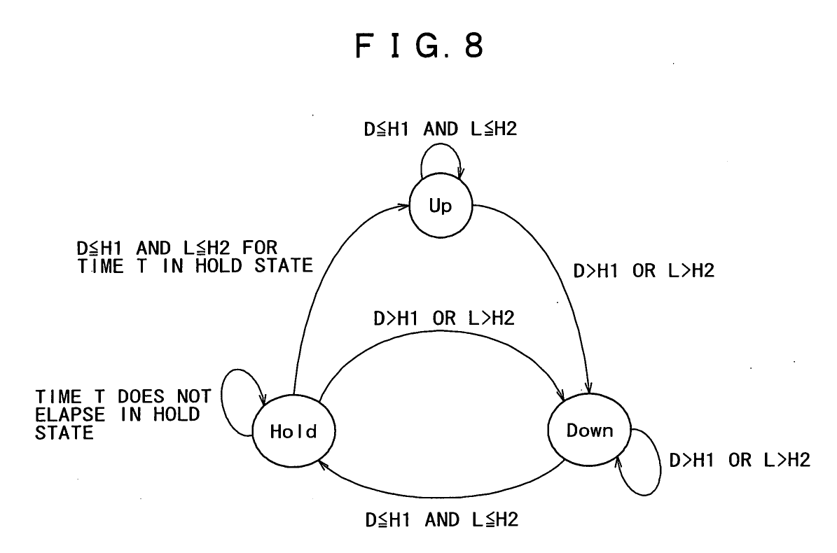

A state transition diagram by the state transition control unit 86 is shown in FIG. 8.

There are three states, that is, an up state for the control of raising the data reception rate, a down state for the control of lowering the data reception rate, and a hold state for the control of holding the data reception rate without changing it.

At the start of control, the state is the hold state. When the state transition control unit 86 determines that the average relative delay increase rate D≦the threshold value H1 and the packet loss rate L≦the threshold value H2 on the basis of a comparison result using formula (10) and formula (11) while keeping the hold state for a fixed time T, the state transition control unit 86 makes the state transition to the up state. When the state transition control unit 86 determines that the average relative delay increase rate D>the threshold value H1, or that the packet loss rate L>the threshold value H2, the state transition control unit 86 makes the state transition to the down state.

In the up state, when the state transition control unit 86 determines that the average relative delay increase rate D≦the threshold value H1 and the packet loss rate L≦the threshold value H2 on the basis of a comparison result using formula (10) and formula (11), the state transition control unit 86 keeps the state in the up state. When the state transition control unit 86 determines that the average relative delay increase rate D>the threshold value H1, or that the packet loss rate L>the threshold value H2, the state transition control unit 86 makes the state transition to the down state.

Moreover, when the state transition control unit 86 determines that the average relative delay increase rate D≦the threshold value H1 and the packet loss rate L≦the threshold value H2 on the basis of the comparison result using formula (10) and formula (11) in the down state, the state transition control unit 86 makes the state transition to the hold state. When the state transition control unit 86 determines that the average relative delay increase rate D>the threshold value H1, or that the packet loss rate L>the threshold value H2, the state transition control unit 86 holds the state in the down state.

The state transition control unit 86 outputs a state transition signal indicating the present state to a reception rate setting unit 87. The reception rate setting unit 87 sets a reception rate on the basis of the state transition signal supplied from the state transition control unit 86, and generates a rate control instruction.

When the state is the down state, the reception rate setting unit 87 calculates a re-set rate R in accordance with the following formula (12):

Re-Set Rate R=Reception Rate×C1 (12)

where C1 indicates a predetermined constant of one or less, or a value of one or less obtained by operating a reciprocal of an average relative delay increase rate separately.

Then, when the state is the up state, the reception rate setting unit 87 calculates the re-set rate R by the following formula (13):

Re-Set Rate R=Reception Rate×C2 (13)

where C2 is a predetermined constant of one or more, or a value of one or more calculated by obtaining the reciprocal of the packet loss rate L.

Incidentally, as for the upper limit of the reception rate, the link speed of the bottleneck link (the data transmission speed in the network status in which no packet losses or no increases of delays occur) which has been previously measured by the use of the Hypertext Transfer Protocol (HTTP), a packet pair or the like may be set as the upper limit. Otherwise, no upper limit may be set.

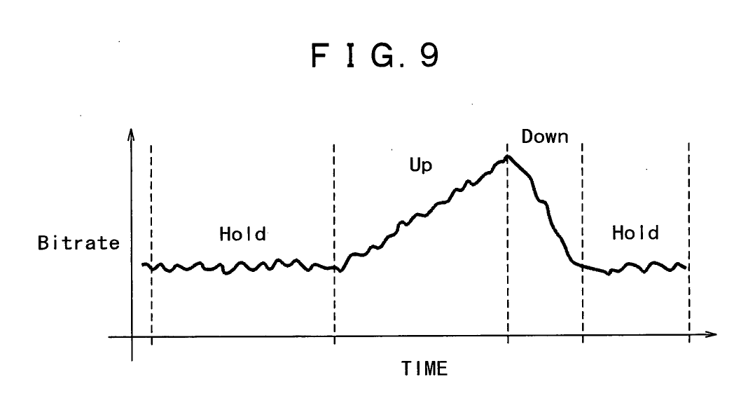

The data reception rate is controlled on the basis of the states shown in the state transition diagram of FIG. 8. Thereby, the data reception rate is controlled in the most suitable state according to the condition of the data transmission path at that time. FIG. 9 is a diagram showing a relation between the states shown in the state transition diagram of FIG. 8 and data reception rates.

There is the case where the state of a data transmission path changes according to time. According to the data reception rate control by the data reception apparatus 32 to which the present invention is applied, the data reception rate is not controlled to converge to a fixed value, but the data reception rate is controlled to increase the data transfer rate by making the state transition to the up state in the state in which the status of the data transmission path is good and no delays or no packet losses occur.

In such a way, the congestion prediction unit 53 generates the rate control instruction as the need arises. The congestion prediction unit 53 outputs the generated rate control instruction to the rate control instruction transmission unit 55.

The rate control instruction transmission unit 55 transmits the rate control instruction to the data transmission apparatus 31 as the APP of the RTCP.

The rate control instruction reception unit 44 of the data transmission apparatus 31 receives the rate control instruction, and supplies the received rate control instruction to the transmission rate control unit 45.

The transmission rate control unit 45 generates a transmission rate control signal on the basis of the rate control instruction supplied from the rate control instruction reception unit 44, and supplies the generated transmission rate control signal to the data generation unit 41.

The data generation unit 41 changes the generation quantity of the data in conformity with the control of the transmission rate control unit 45 as the necessity occurs. Consequently, the data rate of the data transmitted by the data transmission unit 42 is controlled.

In such a way, the data transmission apparatus 31 can transmit packet data at the optimum transmission rate according to the state of a network.

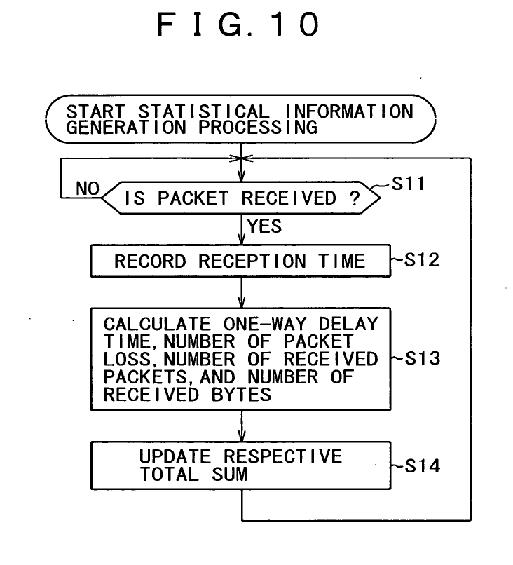

Next, the flowchart of FIG. 10 is referred to while the statistical information generation process executed by the data reception apparatus 32 is described.

At Step S11, the data reception unit 51 determines whether a packet transmitted from the data transmission apparatus 31 has been received through the network 33. When it is determined at Step S11 that the packet has not been received, the process of Step S11 is repeated until it is determined that the packet has been received.

When it is determined at Step S11 that the packet has been received, the data reception unit 51 supplies to the congestion prediction unit 53 the information necessary for obtaining delays of data and packet loss rates such as the reception time, the time stamp, the packet size, the sequence number of the received RTP packet, and the NTP information of the received SR packet of the RTCP. At Step S12, the data operation unit 82 of the congestion prediction unit 53 records the reception time of the received RTP packet in an internal memory.

At Step S13, the data operation unit 82 of the congestion prediction unit 53, as described above, calculates the number of packet losses, the number of received packets, and the received byte count for a one-way delay time in data transmission from the data transmission apparatus 31 to the data reception apparatus 32. At Step S14, the data operation unit 82 updates the respective total sums of the one-way delay time, the number of packet losses, the number of received packets, and the received byte count. After the end of the processing at Step S14, the process returns to Step S11, and the processing after that step is repeated.

By such processing, the data operation unit 82 of the congestion prediction unit 53 generates statistical information.

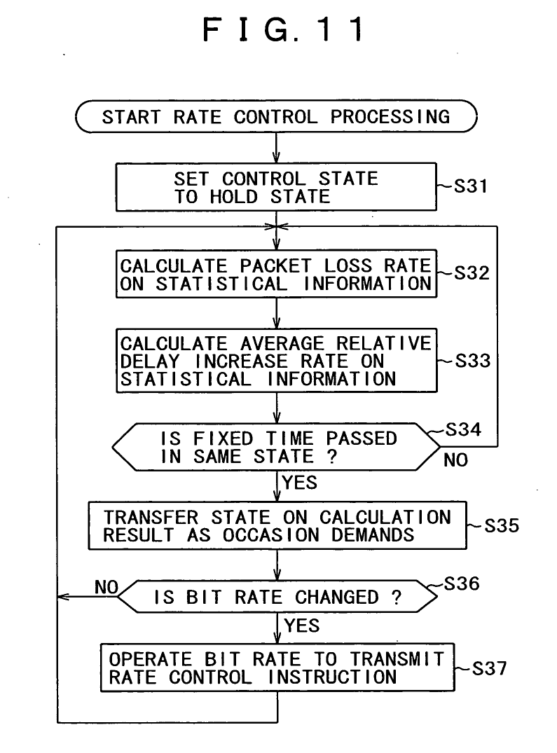

Next, the flowchart of FIG. 11 is referred to while the rate control process to be executed on the basis of the statistical information generated in the statistical information generation process described with reference to FIG. 10 is described.

At Step S31, the state transition control unit 86 sets the state of control to be the hold state.

At Step S32, the packet loss rate operation unit 85 obtains the number of packet losses and the number of received packets among the pieces of the statistical information from the data operation unit 82, and calculates a packet loss rate L by means of formula (9).

At Step S33, the relative delay increase rate operation unit 84 obtains the total sum of the relative delays of the RTP packets among the pieces of the statistical information within a predetermined time from the data operation unit 82. Then, the relative delay increase rate operation unit 84 calculates the average relative delay of the RTP packets, and compares the average relative delay of the RTP packets with the average relative delay of the preceding section by means of formula (8), and calculates the average relative delay increase rate D.

At Step S34, the state transition control unit 86 determines whether a fixed time has passed in the same state. When it is determined at Step S34 that the fixed time has not passed in the same state, the process returns to Step S32, and the processing after that step is repeated.

When it is determined at Step S34 that the fixed time has passed in the same state, the state transition control unit 86 makes the control state transition at Step S35 as shown in FIG. 8 as the need arises on the basis of the packet loss rate L calculated at Step S32 and the average relative delay increasing rate D calculated at Step S33, and supplies the state transition signal to the reception rate setting unit 87.

At Step S36, the reception rate setting unit 87 determines whether the reception rate setting unit 87 should change the reception bit rate on the basis of the state transition signal supplied from the state transition control unit 86. When it is determined that the state transition signal indicates the hold state and the reception bit rate has not been changed at Step S36, the process returns to Step S32, and the processing after that step is repeated.

When it is determined that the state transition signal indicates the up state or the down state and the reception bit rate is changed at Step S36, the reception rate setting unit 87 at Step S37 calculates the bit rate by the use of the above-mentioned formula (12) or formula (13), generates a rate control instruction, and supplies the generated rate control instruction to the rate control instruction transmission unit 55. The rate control instruction transmission unit 55 transmits the rate control instruction to the data transmission apparatus 31 through the network 33.

After the completion of the processing at Step S37, the process returns to Step S32, and the processing subsequent to that step is repeated.

By such processing, the data reception apparatus 32 generates the rate control instruction according to the state of the data transmission path (the network 33), and transmits the generated rate control instruction to the data transmission apparatus 31.

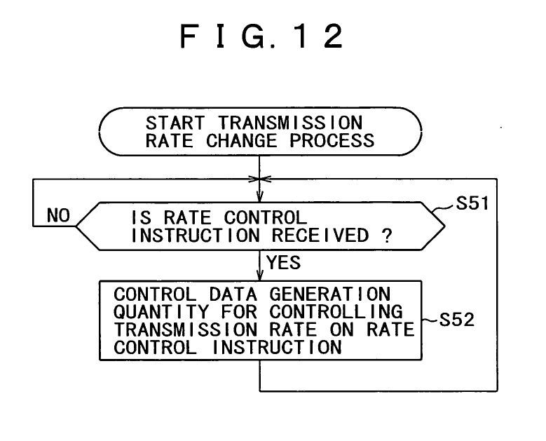

Next, the flowchart of FIG. 12 is referred to while the transmission rate change process executed by the data transmission apparatus 31 is described.

At Step S51, the rate control instruction reception unit 44 of the data transmission apparatus 31 determines whether a rate control instruction has been received. When it is determined at Step S51 that no rate control instructions have been received, the processing at Step S51 is repeated until it is determined that a rate control instruction has been received.

When it is determined at Step S51 that a rate control instruction has been received, the rate control instruction reception unit 44 supplies the received rate control instruction to the transmission rate control unit 45. Consequently, at Step S52, the transmission rate control unit 45 controls the quantity of the data generated by the data generation unit 41 on the basis of the rate control instruction for controlling the transmission rate. By controlling the quantity of the data to be generated, the transmission rate is finally controlled.

After the end of the processing at Step S52, the process returns to Step S51, and the processing after that step is repeated.

By such processing, the data transmission apparatus 31 transmits data to the data reception apparatus 32 at a transmission rate based on the received rate control instruction.

In the above, the system composed of the data transmission apparatus 31 for transmitting packet data, and the data reception apparatus 32 for receiving the packet data have been described. However, the present invention also can be applied to the case where a data transmission and reception apparatus capable of both the transmission and reception of packet data perform transmission and reception of packet data.

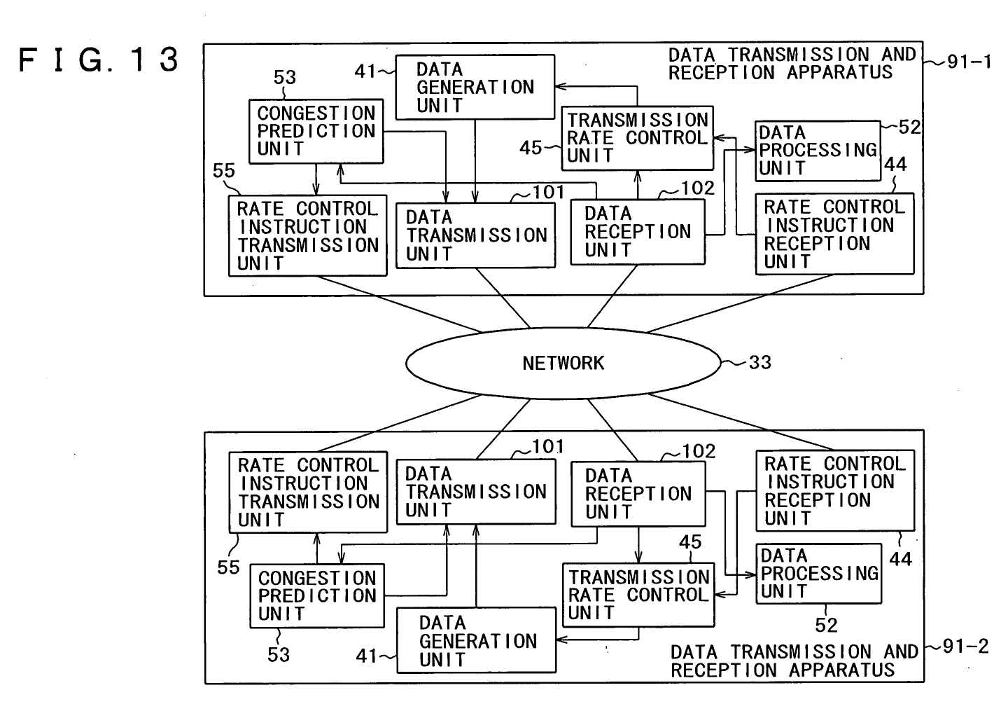

FIG. 13 is a block diagram showing the configurations of a data transmission and reception apparatus 91-1 and a data transmission and reception apparatus 91-2 which can perform both transmission and reception of packet data in another example of the data communication system to which the present invention is applied.

It is noted that the components corresponding to those in FIG. 2 are designated by the same reference numerals as those in FIG. 2, and the descriptions of those components will be suitably omitted.

That is, the data transmission and reception apparatus 91-1 and the data transmission and reception apparatus 91-2, which can perform both transmission and reception, are each provided with the data generation unit 41, the transmission rate control unit 45 and the rate control instruction reception unit 44 like the data transmission apparatus 31 described with reference to FIG. 2. Moreover, the data transmission and reception apparatus 91-1 and the data transmission and reception apparatus 91-2 are each provided with the data processing unit 52, the congestion prediction unit 53 and the rate control instruction transmission unit 55 like the data reception apparatus 32.

Then, the data transmission and reception apparatus 91-1 and the data transmission and reception apparatus 91-2 are each further provided with a data transmission unit 101 and a data reception unit 102. The data transmission unit 101 divides the data supplied from the data generation unit 41 into RTP packets, and adds SR packets to the RTP packets at a predetermined time interval. The data transmission unit 101 further transmits the RTP packets at a transmission rate controlled by the transmission rate control unit 45. When the data transmission unit 101 receives packet data (namely, when the data transmission unit 101 itself functions as an apparatus on the reception side), the data transmission unit 101 generates an RR packet and transmits the generated RR packet through the network 33. The data reception unit 102 receives RR packets by the RCTP transmitted from the transmitter of the packet data, and receives RTP packets and SR packets from another apparatus through the network 33. The data reception unit 102 further separates the data included in the SR packets and the RTP packets, and supplies the data of video, audio, text and the like to the data processing unit 52. Moreover, the data reception unit 102 supplies to the congestion prediction unit 53 the information necessary for estimating the congestion among the pieces of the information included in the RTP packet.

Incidentally, it is needless to say that the present invention can be also applied to data transfer between the data transmission and reception apparatus 91-1 or the data transmission and reception apparatus 91-2, which are described with reference to FIG. 13, and the data transmission apparatus 31 or the data reception apparatus 32, which are described with reference to FIG. 2.

In such a way, the apparatus on the data reception side transmits a rate control instruction to the apparatus on the data transmission side by the use of the RTCP APP. It is thereby possible to realize the rate control by a simpler configuration than the case of using the RTCP RR packet or expanding the RR packet. Moreover, when the estimation of the congestion in the apparatus on the data reception side is advanced highly, there is no necessity for changing the configuration on the data transmission side.

The series of processes described above also can be executed by means of software. The software may be installed in a computer in which the programs constituting the software are incorporated in dedicated hardware, in a general-purpose personal computer which can execute various functions by installing various programs therein, or the like from a recording medium.

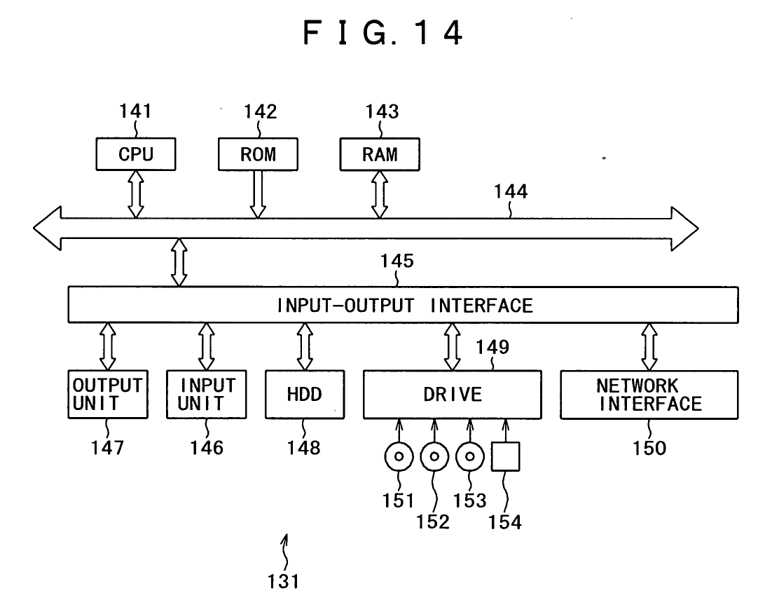

The recording medium may be, as shown in FIG. 14, a magnetic disk 151 (including a flexible disk), an optical disk 152 (including a compact disk read-only memory (CD-ROM), and a digital versatile disk (DVD)), a magneto-optical disk (MO) 153 (including a mini disk (MD) (trade mark)), a package medium composed of a semiconductor memory 154, or the like which include recorded programs and are distributed for supplying the programs to users independently from the computer.

FIG. 14 shows a configuration example of a personal computer 131 executing the processes described above. A central processing unit (CPU) 141 of the personal computer 131 executes various processes in conformity with the programs stored in a ROM 142, or the programs loaded from a hard disc drive (HDD) 148 to a random access memory (RAM) 143. The data or the like necessary for the execution of various processes by the CPU 141 is also suitably stored in the RAM 143.

The CPU 141, the ROM 142 and the RAM 143 are mutually connected through an internal bus 144. An input/output interface 145 is also connected to the internal bus 144.

Connected to the input/output interface 145 are an input unit 146 composed of a keyboard, a mouse and the like, a display composed of a cathode ray tube (CRT), a liquid crystal display (LCD) or the like (not shown), an output unit 147 composed of a speaker or the like, the HDD 148 composed of a hard disk, and a network interface 150 composed of a modem, a terminal adapter, or the like. The network interface 150 performs communication processing through the network 33 such as the Internet.

As the need arises, a drive 149, the magnetic disk 151, the optical disk 152, the magneto-optical disk 153, the semiconductor memory 154 or the like are suitably mounted to the input/output interface 145. Computer programs read from the media are installed in the HDD 148 as the need arises.

Moreover, in the present specification, the steps describing the programs to be recorded on a recording medium of course may be executed serially in the described order. However, the steps alternatively may be executed in parallel or independently.

Incidentally, in the present specification, the term system indicates the whole apparatus composed of a plurality of apparatuses.

Although the invention herein has been described with reference to particular embodiments, it is to be understood that these embodiments are merely illustrative of the principles and applications of the present invention. It is therefore to be understood that numerous modifications may be made to the illustrative embodiments and that other arrangements may be devised without departing from the spirit and scope of the present invention as defined by the appended claims.

1. An information processing apparatus for receiving data from another information processing apparatus through a network, comprising:
a first receiver operable to receive from the another information processing apparatus predetermined information including a transmission state of the data;
a congestion estimation unit operable to estimate congestion of the network on the basis of the predetermined information received by said first receiver;
a control signal generator operable to generate a first control signal for controlling a data transmission rate of the another information processing apparatus on the basis of the congestion estimated by said congestion estimation unit; and
a first transmitter operable to transmit the first control signal generated by said control signal generator to the another information processing apparatus.

2. The information processing apparatus according to claim 1, wherein
said congestion estimation unit includes a delay detection unit operable to detect a delay in data transmission in the network on the basis of the predetermined information received by said first receiver, and
said control signal generator generates the first control signal on the basis of the delay in data transmission detected by said delay detection unit.

3. The information processing apparatus according to claim 2, wherein
the predetermined information includes a first clock for data transmission processing in the another information processing apparatus and, when said first clock coincides with a second clock used for data reception processing in the delay detection unit, said delay detection unit detects the delay in data transmission using the first and second clocks as a first reference clock, and
when the first clock is different from the second clock, said delay detection unit detects the delay in data transmission using a second reference clock different from the first reference clock.

4. The information processing apparatus according to claim 3, wherein
the data is an RTP packet based on RFC 1889; and
the first reference clock is NTP.

5. The information processing apparatus according to claim 3, further comprising:
a reception time measurement unit operable to measure time when the predetermined information is received by said first receiver, wherein
said delay detection unit detects a relative delay in data transmission on the basis of a plurality of pieces of reception time of the predetermined information measured by said reception time measurement unit when the first clock is different from the second clock, and when mapping functions of the second reference clock and the first reference clock cannot be calculated.

6. The information processing apparatus according to claim 2, wherein
the data is composed of a packet in a predetermined size, and
the predetermined information includes information of a reception number of the packet and a number of packet losses.

7. The information processing apparatus according to claim 6, wherein
said congestion estimation unit further includes a packet loss rate detection unit operable to detect a packet loss rate of the packets transmitted from the another information processing apparatus on the basis of the predetermined information received by said first receiver, and
said control signal generator generates the first control signal on the basis of the packet loss rate detected by said packet loss rate detection unit and the delay in data transmission detected by said delay detection unit.

8. The information processing apparatus according to claim 7, wherein
said control signal generator causes the first control signal to lower when said delay detection unit detects an increase in the delay in data transmission equal to or greater than a first predetermined quantity, or when said packet loss rate detection unit detects a packet loss rate equal to or greater than a second predetermined quantity.

9. The information processing apparatus according to claim 7, wherein
said control signal generator causes the first control signal to rise when said delay detection unit does not detect an increase in the delay in data transmission equal to or greater than a first predetermined quantity for a predetermined time, and when said packet loss rate detection unit does not detect a packet loss rate equal to or more than a second predetermined quantity for the predetermined time.

10. The information processing apparatus according to claim 1, wherein said congestion estimation unit includes
a first congestion condition detection unit operable to detect a first condition for estimating the congestion of the network referring to a first time as a reference on the basis of the predetermined information; and
a second congestion condition detection unit operable to detect a second condition for estimating the congestion of the network referring to a second time as a reference on the basis of the predetermined information.

11. The information processing apparatus according to claim 10, wherein
said control signal generator causes the first control signal to lower when said first congestion condition detection unit and said second congestion condition detection unit detect at least one of the first condition and the second condition.

12. The information processing apparatus according to claim 10, wherein
said control signal generator causes the first control signal to rise when said first congestion condition detection unit and said second congestion condition detection unit do not detect the first condition and the second condition for a predetermined time.

13. The information processing apparatus according to claim 1, further comprising:
a second transmitter operable to transmit the data to the another information processing apparatus;
a second receiver operable to receive a second control signal for controlling a data transmission rate by said second transmitter from the another information processing apparatus; and
a controller operable to control the data transmission rate transmitted from said second transmitter on the basis of the second control signal received by said second receiver.

14. The information processing apparatus according to claim 1, wherein the data is an RTP packet in conformity with RFC 1889.

15. A method for receiving data in a first information processing apparatus from another information processing apparatus through a network, comprising:
receiving from the another information processing apparatus predetermined information including a transmission state of the data;
estimating congestion of the network on the basis of the received predetermined information; and
generating a control signal for controlling a data transmission rate of the another information processing apparatus on the basis of the estimated congestion.

16. A recording medium recorded with a computer-readable program for receiving data from another information processing apparatus through a network, comprising:
controlling reception from the another information processing apparatus of predetermined information including a transmission state of the data;
estimating congestion of the network on the basis of the predetermined information; and
generating a control signal for controlling a data transmission rate of the another information processing apparatus on the basis of the estimated congestion.

17. An information processing apparatus for transmitting data to another information processing apparatus through a network, comprising:
a transmitter operable to transmit the data to the another information processing apparatus;
a receiver operable to receive from the another information processing apparatus a control signal for controlling a data transmission rate by said transmitter; and
a controller operable to control the data transmission rate of the data transmitted by said transmitter on the basis of the control signal received by said receiver.

18. A method for transmitting data from a first information processing apparatus to another information processing apparatus through a network, comprising:
receiving from the another information processing apparatus a control signal for controlling a data transmission rate by the first information processing apparatus; and
controlling the data transmission rate of the data transmitted by the first information processing apparatus on the basis of the received control signal.

19. A recording medium recorded with a computer-readable program for transmitting data from a first information processing apparatus to another information processing apparatus through a network, comprising:
controlling reception from the another information processing apparatus of a control signal for controlling a data transmission rate by the first information processing apparatus; and
controlling the data transmission rate of the data transmitted by the first information processing apparatus on the basis of the received control signal.

20. A data communication system, comprising:
a first information processing apparatus for receiving data through a network; and
a second information processing apparatus for transmitting data through the network;
said first information processing apparatus including:
a first receiver operable to receive from said second information processing apparatus predetermined information including a transmission state of the data;
a congestion estimation unit operable to estimate congestion of the network on the basis of the predetermined information received by said first receiver;
a control signal generator operable to generate a control signal for controlling a data transmission rate of said second information processing apparatus on the basis of the congestion estimated by said congestion estimation unit; and
a first transmitter operable to transmit the control signal generated by said control signal generation unit to said second information processing apparatus, and
said second information processing apparatus including:
a second transmitter operable to transmit the predetermined information and the data to said first information processing apparatus;
a second receiver operable to receive from said first information processing apparatus the control signal for controlling the data transmission rate by said second transmitter; and
a controller operable to control the data transmission rate of the data transmitted by said second transmitter on the basis of the control signal received by said second receiver.
